(19) United States
(12) Patent Application Publication
(10) Pub. No.: US 2018/0062867 A1
(43) Pub. Date: Mar. 1, 2018

(54) LAUNCH AND KEEP-ALIVE MECHANISM FOR UNIVERSAL PLATFORM APPLICATION

(71) Applicant: MICROSOFT TECHNOLOGY LICENSING, LLC, Redmond, WA (US)

(72) Inventors: Kishore Kumar Peshkar, Redmond, WA (US); Barnett Trzcinski, Redmond, WA (US); David Tse, Redmond, WA (US)

(73) Assignee: MICROSOFT TECHNOLOGY LICENSING, LLC, Redmond, WA (US)

(21) Appl. No.: 15/366,932

(22) Filed: Dec. 1, 2016

Related U.S. Application Data
(60) Provisional application No. 62/380,974, filed on Aug. 29, 2016.

(51) Int. Cl. H04L 12/18; H04L 29/08

(52) U.S. Cl. CPC H04L 12/1822; H04L 67/10; H04L 12/1895; H04L 12/1827

(57) ABSTRACT

Technologies may be configured to provide a launch and keep-alive mechanism for a universal platform application contained within a meeting management package. A universal platform meeting management application may be launched and a first desktop application may be invoked. The first desktop application may manage display devices in a meeting room based on instructions from the universal platform meeting management application. Upon launch of the first desktop application, a second desktop application may be invoked. The second desktop application may be executed independently from the universal platform meeting management application as a watchdog process. The second desktop application may monitor the universal platform meeting management application. In response to detecting an exit of the universal platform meeting management application, the universal platform meeting management application may be re-launched. The universal platform meeting management application may be terminated to allow a restart of the meeting management package.

### CROSS-REFERENCE TO RELATED APPLICATION

This Application claims priority under 35 U.S.C. §119(e) to U.S. Provisional Patent Application Ser. No. 62/380,974 filed on Aug. 29, 2016. The disclosure of the U.S. Provisional patent application is hereby incorporated by reference in its entirety.

### BACKGROUND

Conference rooms typically include a projection display or a similar display device for displaying content, projecting online meeting content, and enabling additional collaborative efforts. Conventional conference room displays may be typically controlled by a dedicated computer or by a computing device of a meeting attendant. As such, display management may be performed through the display management programs in individual computers.

Modern conference rooms may be equipped with enhanced computing devices to accommodate the increasingly complex needs of physical and online meetings, collaboration applications, online content, and additional functionality that users have come to expect. Thus, meeting management applications may coordinate various functionalities associated with meeting room operations. Such applications may need to have an active display available whenever there are people in a conference room to provide a satisfactory user experience. However, meeting management applications, like others, may deactivate sometimes due to software, hardware, or network issues; this may force meeting attendants in a conference room to manually activate the systems.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments may be configured to provide a launch and keep-alive mechanism for a universal platform application contained within a meeting management package. A universal platform meeting management application may be launched and a first desktop application may be invoked. The first desktop application may manage display devices in a meeting room based on instructions from the universal platform meeting management application. Upon launch of the first desktop application, a second desktop application may be invoked. The second desktop application may be executed independently from the universal platform meeting management application as a watchdog process. The second desktop application may monitor the universal platform meeting management application. In response to detecting an exit of the universal platform meeting management application, the universal platform meeting management application may be re-launched. The universal platform meeting management application may be terminated to allow a restart of the meeting management package.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example schematic diagram illustrating an example process to provide a launch and keep-alive mechanism for a universal platform application contained within a meeting management package;

FIG. 2 illustrates an example schematic diagram illustrating an example process to provide a launch and keep-alive mechanism for a universal platform application contained within a meeting management package;

FIG. 3 illustrates a conceptual diagram of an example process to utilize sensors to detect activity within a meeting room;

FIG. 4 is a networked environment, where a system according to embodiments may be implemented;

FIG. 5 is a block diagram of an example general purpose computing device, which may be used to provide a launch and keep-alive mechanism for universal platform applications; and

FIG. 6 includes a logic flow diagram that illustrates a process to provide a launch and keep-alive mechanism for a universal platform application contained within a meeting management package, according to at least some embodiments disclosed herein.

### DETAILED DESCRIPTION

As briefly described above, embodiments may be configured to provide a launch and keep-alive mechanism for a universal platform application contained within a meeting management package. A universal platform meeting management application may be launched and a first desktop application may be invoked. The universal platform meeting management application may be configured to perform actions, such as, recording the meeting, adjusting audio controls, adjusting video controls, managing online attendants, and managing presented content. The first desktop application may manage display devices in a meeting room based on instructions from the universal platform meeting management application. The display devices may include one or more wall projection systems. The meeting room may include sensors configured to detect activity within the meeting room. The sensors may include one or more of: motion sensors, heat sensors, pressure sensors, and mechanical sensors. The activity within the meeting room may include one or more of: movement of participants and speech by the participants.

In some examples, the first desktop application may be further configured to detect an inactivity time period associated with a select display device of the display devices and reactivate the select display device of the display devices in the meeting room based on instructions received from the universal platform meeting management application. Upon launch of the first desktop application, a second desktop application may be invoked. The second desktop application may be executed independently from the universal platform meeting management application as a watchdog process. In some examples, the second desktop application may be configured to execute the watchdog process to detect faults within the monitoring of the universal platform meeting management application and initiate corrective actions associated with the universal platform meeting management application.

In other examples, the second desktop application may monitor the universal platform meeting management application. In response to detecting an exit of the universal platform meeting management application, the universal platform meeting management application may be re-launched. The universal platform meeting management application may be terminated to allow a restart of the meeting management package.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed/executed on a desktop platform and a mobile platform. Some universal platform applications may not indicate having been written for a specific operating system or platform in their manifest build; instead, they may target one or more device families, such as a PC, smartphone, tablet, or gaming systems. These extensions may allow the application to automatically utilize the capabilities that are available to the particular device it is currently running on. The platform-agnostic nature of these applications may allow enhanced user experience aspects in addition to efficiency and reduced complexity. For example, a universal platform application executed on a smartphone may start behaving the way it would if it were running on a PC when the smartphone is connected to a desktop computer or a suitable docking station. On the other hand, being platform agnostic may mean for some of these applications limitations over platform-specific applications. For example, a number and type of Application Programming Interfaces (APIs) available in the application may be limited. Thus, a functionality of a universal platform application may also be subject to constraints based on its design such as the ability re-launch itself upon crashing or experiencing an unintentional exit.

Compared to universal platform applications, desktop applications, as referred to herein, are typically platform-specific such as operating system, operating system version, device, etc. While their specificity may make it more difficult to manage desktop applications on different devices or operating systems, it may also provide them with a higher degree of freedom with respect to functionality. Operating system or device specific APIs may be provided in desktop applications, for example. Thus, desktop applications may lend themselves more toward certain functionality. For example, functionality that is associated with monitoring and reacting to events that happen at operating system or hardware level. Following the example provided above, a desktop application may be configured to re-launch itself upon a crash or unintentional exit.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can, for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for interrupting a synchronization of content between a client device and a cloud-based storage service. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

The technical advantages of providing a launch and keep-alive mechanism for a universal platform application contained within a meeting management package may include, among others, improved computing device performance, reduced processing and network bandwidth usage associated with a computing device, energy savings associated with the computing device, and improved user interaction by allowing users to find active meeting management user interfaces at all times in the meeting room without having to launch or re-launch the associated systems.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with communications.

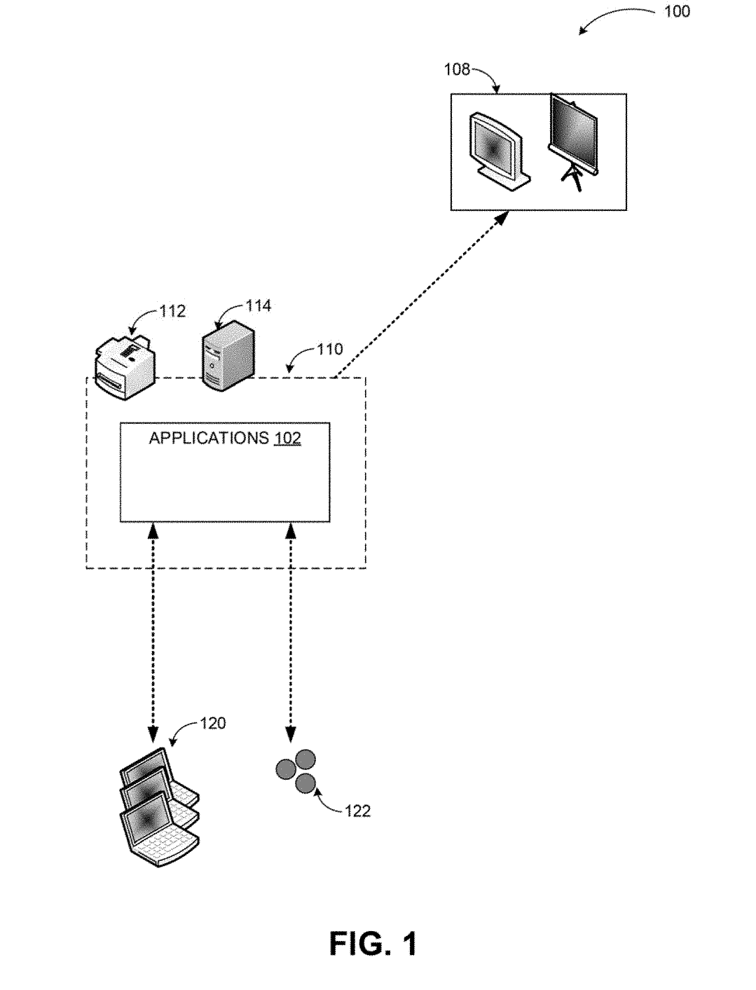

FIG. 1 illustrates an example schematic diagram illustrating an example process to provide a launch and keep-alive mechanism for a universal platform application contained within a meeting management package, according to at least some embodiments disclosed herein.

As illustrated in a diagram 100, an example system may include a computing device 112. The computing device 112 may be a special purpose computing device, among other examples. The computing device 112 may be configured to provide a launch and keep-alive mechanism for universal platform applications. The computing device 112 may include a communication interface, a memory, and/or a processor, among other components.

The communication interface may be configured to facilitate an exchange of data with other computing devices 120. The data may include audio data (e.g., associated with a meeting or associated with one or more attendants of the meeting), movement data (e.g., movement of the one or more attendants), and/or visual data (e.g., associated with the meeting), among other types of data within a meeting room. The memory may be configured to store instructions associated with one or more applications 102 (e.g., a meeting management application, a first desktop application, and/or a second desktop application, among others). The one or more applications 102 may be executed on any device and software platform. As such, the one or more applications 102 may be subject to constraints of some of the software platforms they are executed on.

The processor may be coupled to the communication interface and the memory. The processor may be configured to receive and execute a meeting management package 10. The meeting management package 110 may include the one or more applications 102. The one or more applications 102 may be configured to perform actions associated with managing presentations, communications, and controls associated with the meeting within the meeting room. The actions may include, among others, recording audio associated with the meeting, modifying audio controls associated with the meeting, modifying video controls associated with the meeting, managing online attendants to the meeting, and managing presented content associated with the meeting.

According to further examples, the meeting room may include sensors 122 configured to detect activity within the meeting room. The sensors 122 may include one or more of: motion sensors, heat sensors, pressure sensors, and mechanical sensors. The activity within the meeting room may include one or more of: movement of participants and speech by the participants. The movement by the participants may include one or more of the participants executing actions, such as, opening a door to the meeting room, closing the door to the meeting room, opening a window of the meeting room, and/or closing the window of the meeting room, etc.

Upon initial launch of the one or more applications 102, the one or more applications 102 may invoke the first desktop application. The first desktop application may be configured to manage one or more display devices 108 in the meeting room based on instructions from the one or more applications 102. The one or more display devices 108 may include one or more wall projection systems.

Upon launch of the first desktop application, the second desktop application may be invoked. The second desktop application may be configured to be executed independently from the one or more applications 102 as a watchdog process. As described herein, the watchdog process may be, in some examples, an electronic timer used to detect and recover from computer malfunctions. During normal operation, the computing device 121 regularly resets the watchdog timer to prevent it from elapsing or timing out. If, due to a hardware fault or a program error, the computing device 112 fails to reset the watchdog timer, the timer may elapse and generate a timeout signal. The timeout signal may be used to initiate one or more corrective action. The one or more corrective actions may include placing the computer system in a safe state and restoring normal system operations of the computing device 112.

The second desktop application may also be further configured to monitor the one or more applications 102. In response to detecting an exit of the one or more applications 102, the second desktop application may be configured to re-launch the one or more applications 102. Further, the second desktop application may be configured to terminate the one or more applications 102 to allow a restart of the meeting management package 110.

In some examples, the one or more applications 102 may be executed on a server 114 associated with the computing device 112. According to some examples, the server 114 may be configured to provide data presentation functionality associated with a database. According to some examples, a service may be configured to be integrated with the one or more applications 102. A participant may execute a thin version (e.g., a web browser) of a select application of the one or more applications 102 through the computing device 112. The computing device 112 may include a desktop computer, a laptop computer, a tablet computer, a smart phone, a vehicle mount computer, or a wearable computer, among other devices. In other examples, the participant may execute a thick version (e.g., a locally-installed version) of the select application of the one or more applications 102 through the computing device 112.

According to other examples, the service may be configured to interact with the one or more applications 102 over one or more networks. The one or more networks may comprise any topology of servers, clients, Internet service providers, and communication media. In some examples, the select application of the one or more applications 102 may be a productivity application. The productivity application may include a word-processing application, a spreadsheet application, a presentation application, or a notebook application, among other examples. According to other examples, the select application of the one or more applications 102 may be hosted by the service. A participant interface may facilitate communication over the one or more networks and between the service and the select application of the one or more applications 102.

While the example system in FIG. 1 has been described with specific components including the one or more applications 102, the one or more display devices 108, the meeting management package 110, the computing device 112, the server 114, the other computing devices 120, and the sensors 122, embodiments are not limited to these components or system configurations and can be implemented with other system configuration employing fewer or additional components.

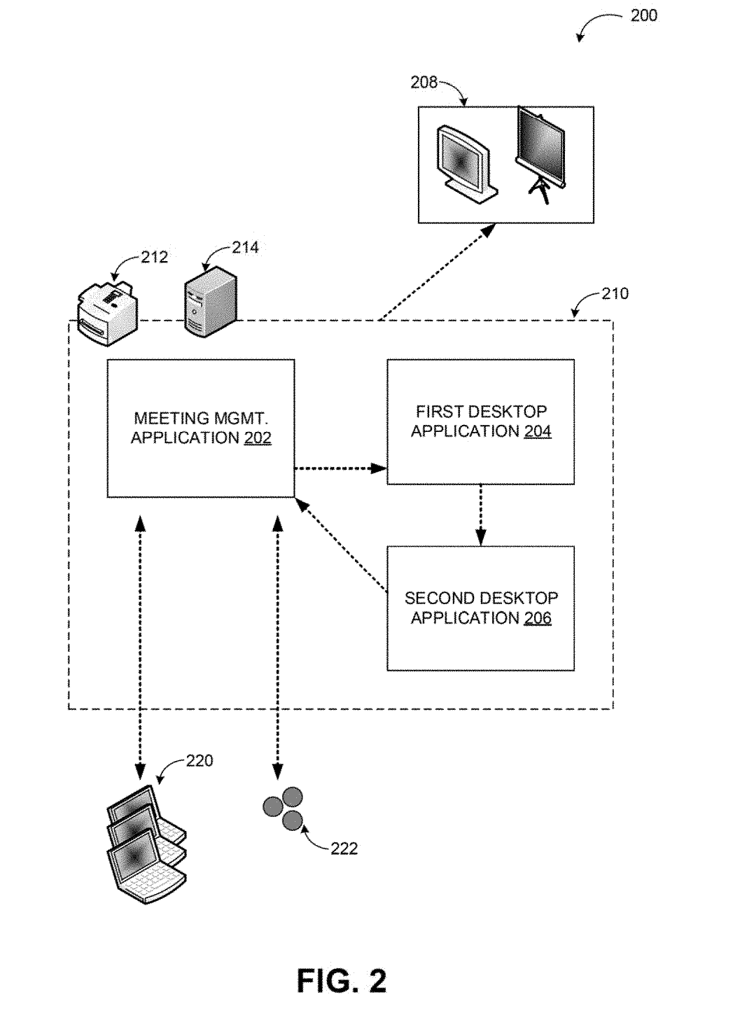

FIG. 2 illustrates an example schematic diagram illustrating an example process to provide a launch and keep-alive mechanism for a universal platform application contained within a meeting management package, according to at least some embodiments disclosed herein.

Similar to the diagram 100 illustrated in FIG. 1, a diagram 200 may include an example system. The example system may include a computing device 212. The computing device 212 may be configured to provide a launch and keep-alive mechanism for universal platform applications. The computing device 212 may include a communication interface, a memory, and/or a processor, among other components. The communication interface may be configured to facilitate an exchange of data with other computing devices 220. The memory may be configured to store instructions associated with a universal platform meeting management application 202.

In other examples, the universal platform meeting management application 202 may be executed on a server 214 associated with the computing device 212. According to some examples, the server 214 may be configured to provide data presentation functionality associated with a database. The server may include a communication module, a memory, and a processor.

The processor may be coupled to the communication interface and the memory. The processor may be configured to receive and execute a meeting management package 210. The meeting management package 210 may include the universal platform meeting management application 202, a first desktop application 204, and/or a second desktop application 206, among others. The universal platform meeting management application 202 may be configured to perform actions associated with managing presentations, communications, and controls associated with a meeting room. The actions may include, among others, recording audio associated with the meeting, modifying audio controls associated with the meeting, modifying video controls associated with the meeting, managing online attendants to the meeting, and managing presented content associated with the meeting.

The meeting room may include sensors 222 configured to detect activity within the meeting room. The sensors 222 may include one or more of: motion sensors, heat sensors, pressure sensors, and mechanical sensors. The activity within the meeting room may include one or more of: movement of participants and speech by the participants.

Upon initial launch of the universal platform meeting management application 202, the universal platform meeting management application 202 may invoke the first desktop application 204. The first desktop application 204 may be configured to manage one or more display devices 208 in the meeting room based on instructions from the universal platform meeting management application 202. The one or more display devices 208 may include one or more wall projection systems.

Upon launch of the first desktop application 204, the second desktop application 206 may be invoked. The second desktop application 206 may be configured to be executed independently from the universal platform meeting management application 202 as a watchdog process. The second desktop application 206 may also be further configured to monitor the universal platform meeting management application 202. In a further example, the second desktop application 206 may detect platform availability associated with the computing device 212 to relaunch the universal platform meeting management application 202.

In response to detecting an exit of the universal platform meeting management application 202, the second desktop application 206 may be configured to re-launch the universal platform meeting management application 202. Further, the second desktop application 206 may be further configured to terminate the universal platform meeting management application 202 to allow a restart of the meeting management package 210.

In some examples, a minimum duration period between a first launching of the universal platform meeting management application 202 and a second launching of the universal platform meeting management application 202 may be defined. The minimum duration period may include a timing period and may be measured in one of: months, days, hours, minutes, or seconds. The minimum duration period may be defined to avoid frequent launches of the universal platform meeting management application 202 due to a continued issue (e.g., a software issue or a hardware issue, among other examples) that causes the universal platform meeting management application 202 to crash. The first launching and the second launching of the universal platform meeting management application 202 may be successive launchings.

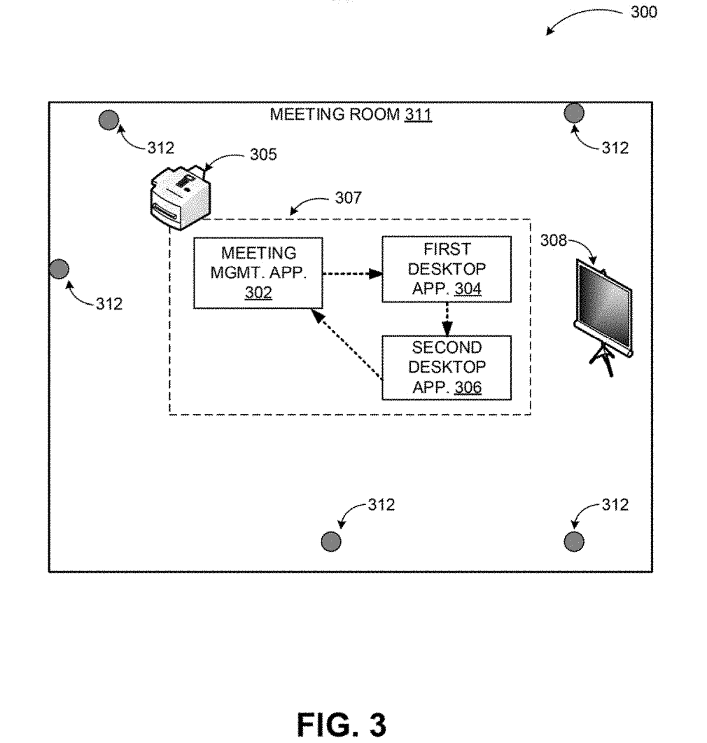

FIG. 3 illustrates a conceptual diagram of an example process to utilize sensors to detect activity within a meeting room, according to at least some embodiments disclosed herein.

As shown in a diagram 300, a computing device 305 (e.g., a special purpose computing device) may include a communication interface, a memory, and/or a processor, among other components. The communication interface may be configured to facilitate an exchange of data with other computing devices. The memory may be configured to store instructions associated with a universal platform meeting management application. The processor may be coupled to the communication interface and the memory. The processor may be configured to receive and execute a meeting management package 307. The meeting management package 307 may include the universal platform meeting management application 302.

The universal platform meeting management application 302 may be configured to perform actions associated with managing presentations within a meeting room 311, managing communications (e.g., audio and video) within the meeting room 311, and controls associated with the meeting room 311. The actions may include, among others, recording audio associated with the meeting (e.g., speech of meeting attendants), recording video associated with the meeting (e.g., a presentation given during the meeting), modifying audio controls associated with speech of the meeting attendants during the meeting, modifying video controls associated with the meeting, managing online attendants to the meeting, and managing presented content associated with the meeting.

According to some examples, the meeting room 311 may include sensors 312 configured to detect activity within the meeting room 311. The sensors 312 may include motion sensors, heat sensors, pressure sensors, and/or mechanical sensors, among others. The activity within the meeting room 311 may include one or more of: movement of participants and speech by the participants. In other examples, the heat sensors may determine a number of attendants within the meeting room 311. In additional examples, the pressure sensors may determine the number of meeting attendants sitting within the meeting room 311, standing within the meeting room 311, and/or walking around the meeting room, etc.

According to further examples, the universal platform meeting management application 302 may be further configured to receive one or more of: content to be presented from another computing device (e.g., another presentation), a communications input from the other computing device (e.g., an audio input, a graphical input, and/or a textual input, etc.), and additional data (e.g., additional audio data, movement data, and/or video data) from the other computing device. In other examples, the universal platform meeting management application 302 may be further configured to exit due to a software conflict, a hardware issue, and/or a network issue, among other examples. The hardware issue may include an overheating of the computing device 305 and/or a lack of available memory for the computing device 305, among other examples.

Upon initial launch of the universal platform meeting management application 302, the universal platform meeting management application 302 may invoke a first desktop application 304. The first desktop application 304 may be configured to manage a display device 308 in the meeting room 311 based on instructions from the universal platform meeting management application 302. The display device 308 may include one or more wall projection systems. In other examples, the first desktop application is further configured to detect an inactivity time period associated with the display device 308. In response to detection of the inactivity time period, the computing device 305 may turn off the display device 308.

Upon launch of the first desktop application 304, a second desktop application 306 may be invoked. The second desktop application 306 may be configured to be executed independently from the universal platform meeting management application 302 as a watchdog process. The second desktop application 306 may also be further configured to monitor the universal platform meeting management application 302. According to further embodiments, the second desktop application 306 may be configured to execute the watchdog process to, at least, detect faults within the monitoring of the universal platform meeting management application 302 and/or initiate corrective actions associated with the universal platform meeting management application 302.

In response to detecting an exit of the universal platform meeting management application 302, the second desktop application 306 may be configured to re-launch the universal platform meeting management application 302. Further, the second desktop application 306 may be further configured to terminate the universal platform meeting management application 302 to allow a restart of the meeting management package 307.

According to further examples, one or more messages may be displayed in real-time on the display devices 308 in response to detecting the exit of the universal platform meeting management application 302. A textual scheme, a graphical scheme, an audio scheme, an animation scheme, a coloring scheme, a highlighting scheme, and/or a shading scheme may be employed to further enhance user interaction with a client interface of the meeting management service or application that provides a launch and keep-alive mechanism for universal platform applications. In some examples, the one or more messages may prompt meeting participants to provide user-definable input into the one or more messages.

In response to receiving the user-definable input, the second desktop application 306 may re-launch the universal platform meeting management application 302. Further, the second desktop application 306 may be further configured to terminate the universal platform meeting management application 302 to allow a restart of the meeting management package 307.

The examples provided in FIG. 1 through FIG. 3 are illustrated with specific systems, services, applications, modules, and notifications. Embodiments are not limited to environments according to these examples. Embodiments to provide a launch and keep-alive mechanism for a universal platform application contained within a meeting management package may be implemented in environments employing fewer or additional systems, services, applications, engines, modules, and notifications. Furthermore, the example systems, services, applications, engines, modules, and notifications shown in FIG. 1 through FIG. 3 may be implemented in a similar manner with other values using the principles described herein.

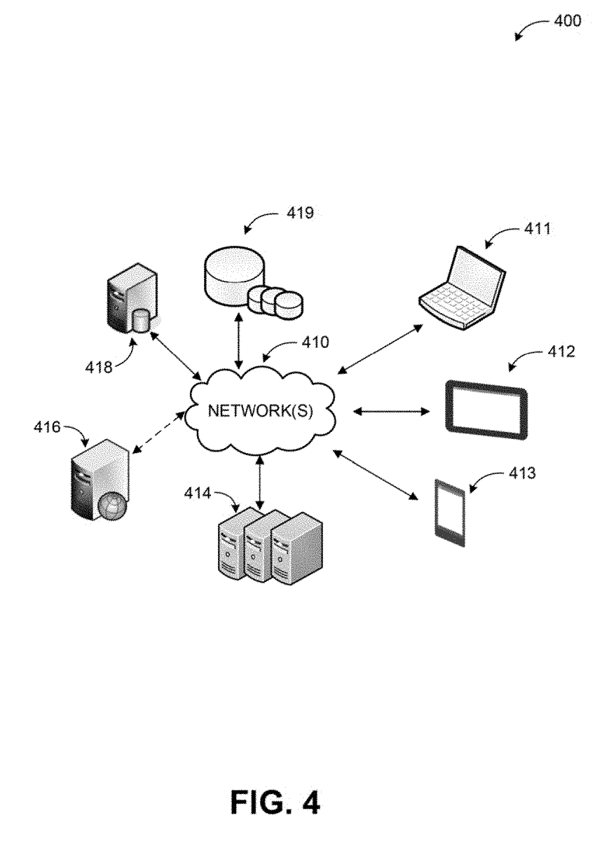

FIG. 4 is a networked environment, where a system according to embodiments may be implemented.

As shown in a diagram 400, a conference room management or meeting management service with a launch and keep-alive mechanism for universal platform meeting management applications may be implemented in a networked environment over one or more networks, such as network 410. Participants may access the conference room management or meeting management service through locally installed client applications (e.g., the universal platform meeting management application 302, the first desktop application 304, and/or the second desktop application 306, among others) or thin (e.g., browser-based) client applications executed on a variety of computing/client devices (e.g., a laptop 411, a tablet 412, and/or a smartphone 413, etc.). Functionality within the conference room management or meeting management service may be provided by a communication module or a communication application executed within the conference room management or meeting management service executed on servers 414 or processing server 416.

The conference room management or meeting management service, as discussed herein, may be implemented via software executed over servers 414. The servers 414, may include one or more processing server 416, where at least one of the one or more processing servers 416 may be configured to execute one or more applications associated with the conference room management or meeting management service. The conference room management or meeting management service may store data associated with a meeting in a data store 419 directly or through a database server 418.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

Many other configurations of computing devices, applications, engines, modules, data sources, and data distribution systems may be employed to provide a launch and keep-alive mechanism for a universal platform application contained within a meeting management package. Furthermore, the networked environments discussed in FIG. 4 are for illustration purposes only. Embodiments are not limited to the example applications, modules, engines, or processes.

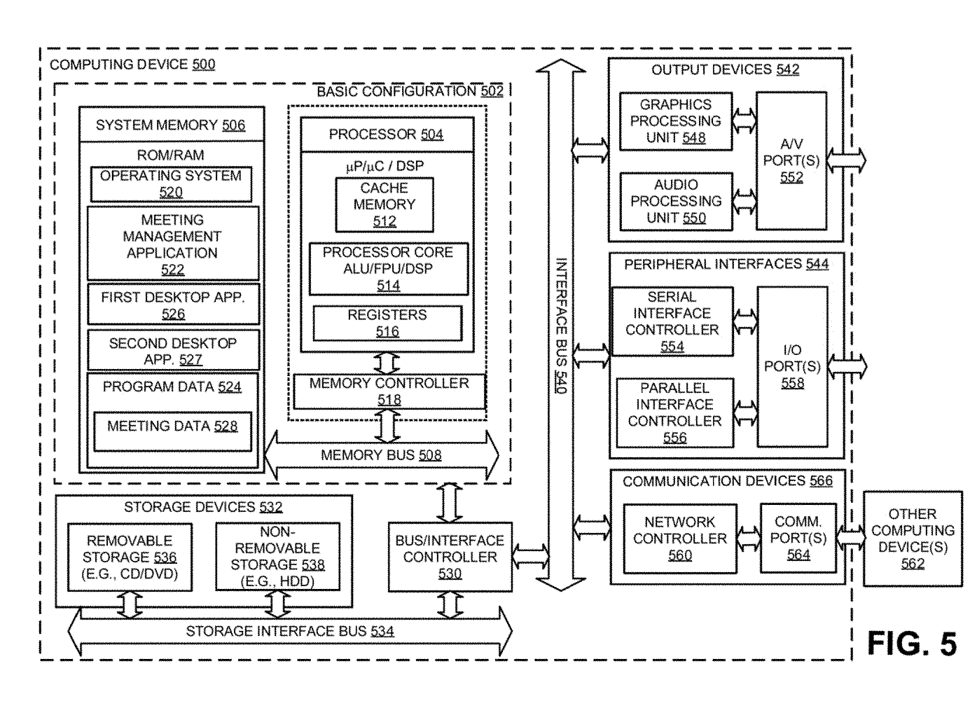

FIG. 5 is a block diagram of an example general purpose computing device, which may be used to provide a launch and keep-alive mechanism for universal platform applications, according to at least some embodiments described herein.

For example, a computing device 500 may be used as a server, a desktop computer, a portable computer, a smart phone, a special purpose computer, or a similar device. In an example basic configuration 502, the computing device 500 may include one or more processors 504 and a system memory 506. A memory bus 508 may be used for communicating between the processor 504 and the system memory 506. The example basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The one or more processor cores 514 may (each) include an arithmetic logic unit (ALU), a floating point unit (FPU), a digital signal processing core (DSP Core), or any combination thereof. An example memory controller 518 may also be used with the processor 504, or in some implementations the example memory controller 518 may be an internal part of the processor 504.

Depending on the desired configuration, the system memory 506 may be of any type including but not limited to volatile memory (such as RAM) and non-volatile memory (such as ROM, flash memory, etc.), or any combination thereof. The system memory 506 may include an operating system 520, a universal platform meeting management application 522, a first desktop application 526, a second desktop application 527, and program data 524. The universal platform meeting management application 522 may be configured to perform actions associated with managing presentations, communications, and controls associated with a meeting room. Further, the universal platform meeting management application 522 may be configured to, upon initial launch, invoke the first desktop application 526. The first desktop application 526 may be configured to manage display devices in the meeting room based on instructions from the universal platform meeting management application 522. Upon launch, the first desktop application 526 may further be configured to invoke the second desktop application 527. The second desktop application 527 may be configured to execute independently from the universal platform meeting management application 522 as a watchdog process. The second desktop application 527 may be further configured to monitor the universal platform meeting management application 522. In additional examples, in response to detecting an exit of the universal platform meeting management application 522, second desktop application 527 may re-launch the universal platform meeting management application 522. In further examples, the second desktop application 527 may be further configured to terminate the universal platform meeting management application 522 to allow a restart of the meeting management package. The program data 524 may include data from the meeting (e.g., meeting data 528) and/or data received from other computing devices.

The computing device 500 may have additional features or functionality, and additional interfaces to facilitate communications between the example basic configuration 502 and any desired devices and interfaces. For example, a bus/interface controller 530 may be used to facilitate communications between the example basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and an example communication device 546) to the example basic configuration 502 via the bus/interface controller 530. Some of the one or more output devices 542 may include a graphics processing unit 548 and an audio processing unit 550, which may be configured to communicate with various external devices, such as a display or speakers via one or more A/V ports 552. The one or more peripheral interfaces 544 may include a serial interface controller 554 or a parallel interface controller 556, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 558. The example communication device 546 may include a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

The computing device 500 may be implemented as a part of a general purpose or a specialized server, a mainframe, or similar computer that includes any of the above functions. The computing device 500 may also be implemented as a personal computer, including both laptop computer configurations and non-laptop computer configurations.

Example embodiments may also include methods to provide a launch and keep-alive mechanism for a universal platform application contained within a meeting management package. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

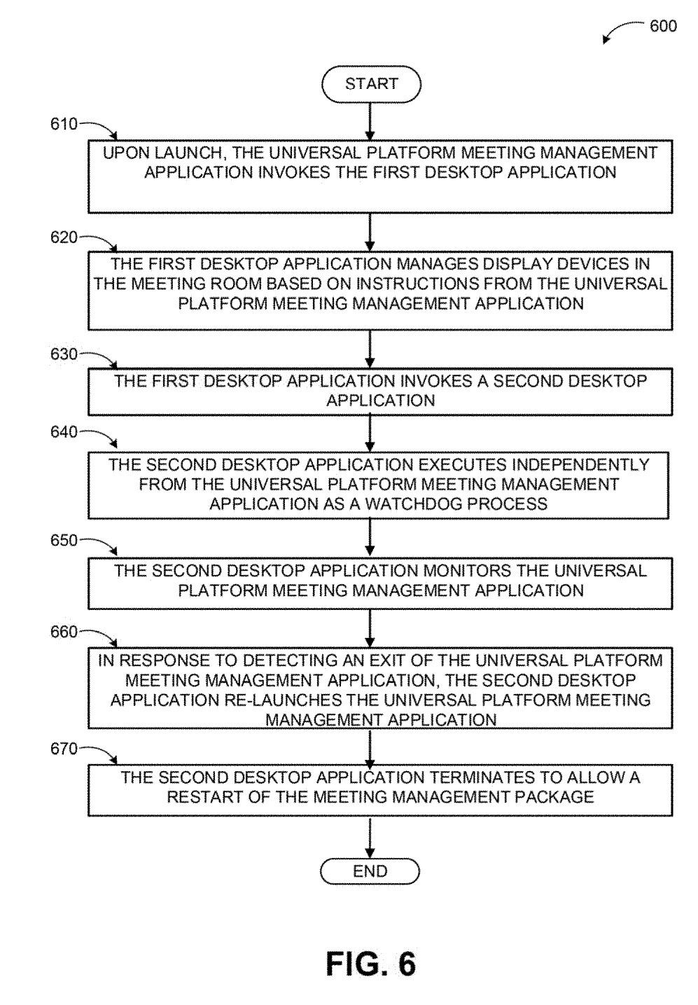

FIG. 6 includes a logic flow diagram that illustrates a process to provide a launch and keep-alive mechanism for a universal platform application contained within a meeting management package, according to at least some embodiments disclosed herein.

Process 600 may be implemented on a computing device, server, or other system. An example computing device may include a communication interface, a memory, and a processor. The communication interface may be configured to facilitate an exchange of data with other computing devices. The memory may be configured to store instructions associated with a meeting management application. The processor may be coupled to the communication interface and the memory. The processor may be configured to receive and execute a meeting management package. The meeting management package may include a universal platform meeting management application.

Process 600 begins with operation 610, where upon launch, the universal platform meeting management application may invoke a first desktop application. In some examples, the first desktop application may be configured to detect an inactivity time period associated with a select display device. In response, the first desktop application may reactivate the select display device in the meeting room based on instructions received from the universal platform meeting management application.

Operation 610 may be followed by operation 620, where the first desktop application may manage display devices in the meeting room based on instructions from the universal platform meeting management application. In some examples, the meeting room may include sensors configured to detect activity within the meeting room. The sensors may include one or more of: motion sensors, heat sensors, pressure sensors, and mechanical sensors. The activity within the meeting room may include one or more of: movement of participants and speech by the participants.

Operation 620 may be followed by operation 630, where the first desktop application may invoke a second desktop application. Operation 630 may be followed by operation 640, where the second desktop application may be executed independently from the universal platform meeting management application as a watchdog process. In some examples, the second desktop application may be configured to execute the watchdog process to detect faults within the monitoring of the universal platform meeting management application and/or to initiate corrective actions associated with the universal platform meeting management application.

Operation 640 may be followed by operation 650, where the second desktop application may monitor the universal platform meeting management application. In some examples, the actions performed by the universal platform meeting management application may include one or more of: recording the meeting, adjusting audio controls, adjusting video controls, managing online attendants, and managing presented content. In further examples, monitoring of the universal platform meeting management application may include detecting one or more of a crash of the universal platform meeting management application and a deactivation of the universal platform meeting management application.

Operation 650 may be followed by operation 660, where, in response to detecting an exit of the universal platform meeting management application, the second desktop application may re-launch the universal platform meeting management application. Operation 660 may be followed by operation 670, where the second desktop application may terminate to allow a restart of the meeting management application.

The operations included in process 600 are for illustration purposes. Providing a launch and keep-alive mechanism for universal platform applications, may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a means for providing a launch and keep-alive mechanism for a universal platform application contained within a meeting management package may be described, which includes a means for detecting a launch of a universal platform meeting management application configured to perform actions associated with managing presentations, communications, and controls associated with a meeting room. Upon initial launch of the universal platform meeting management application, a means for invoking a first desktop application may further be described. Additionally, the means for providing the launch and keep-alive mechanism for the universal platform application contained within the meeting management package may further include a means for managing, by the first desktop application, display devices in the meeting room based on instructions from the universal platform meeting management application and upon launch of the first desktop application, a means for invoking a second desktop application. Further, a means for executing the second desktop application independently from the universal platform meeting management application as a watchdog process and a means for monitoring, by the second desktop application, the universal platform meeting management application may also be described. In response to detecting an exit of the universal platform meeting management application, a means for re-launching the universal platform meeting management application may be described. A means for terminating the universal platform meeting management application to allow a restart of the meeting management package may also be described.

According to further examples, a computing device to provide a launch and keep-alive mechanism for universal platform applications may be described. The computing device may include a communication interface, a memory, and a processor. The communication interface may be configured to facilitate exchange of data with other computing devices. The memory may be configured to store instructions associated with a meeting management application. The processor may be coupled to the communication interface and the memory. The processor may be configured to receive and execute a meeting management package. The meeting management package may include a universal platform meeting management application. The universal platform meeting management application may be configured to perform actions associated with managing presentations, communications, and controls associated with a meeting room. Upon initial launch, the universal platform meeting management application may be further configured to invoke a first desktop application. Upon launch, the first desktop application may be configured to invoke a second desktop application. The second desktop application may be configured to execute independently from the universal platform meeting management application as a watchdog process. The second desktop application may be further configured to monitor the universal platform meeting management application. In response to detecting an exit of the universal platform meeting management application, the second desktop application may be further configured to re-launch the universal platform meeting management application and terminate the universal platform meeting management application to allow a restart of the meeting management package.

According to other examples, the display devices may include one or more wall projection systems. According to further examples, the meeting room may include sensors configured to detect activity within the meeting room. The sensors may include one or more of: motion sensors, heat sensors, pressure sensors, and mechanical sensors. The activity within the meeting room may include one or more of: movement of participants and speech by the participants.

According to additional examples, the first desktop application may be further configured to detect an inactivity time period associated with a select display device of the display devices and reactivate the select display device of the display devices in the meeting room based on instructions received from the universal platform meeting management application. In other examples, the monitoring of the universal platform meeting management application may include detecting one or more of a crash of the universal platform meeting management application and a deactivation of the universal platform meeting management application.

According to some examples, the second desktop application may be further configured to execute the watchdog process to detect faults within the monitoring of the universal platform meeting management application and initiate corrective actions associated with the universal platform meeting management application. In some examples, the actions performed by the universal platform meeting management application may include one or more of: recording the meeting, adjusting audio controls, adjusting video controls, managing online attendants, and managing presented content.

According to further examples, the universal platform meeting management application may be further configured to: receive content to be presented from another computing device, a communications input from the other computing device, and/or additional data from the other computing device. The universal platform meeting management application may be further configured to exit due to one or more of: a software conflict, a hardware issue, and a network issue. The hardware issue may include one or more of an overheating of the computing device and a lack of available memory for the computing device.

According to some examples, a method executed on a computing device to provide a launch and keep-alive mechanism for a universal platform application contained within a meeting management package may be described. The method may include detecting a launch of a universal platform meeting management application configured to perform actions associated with managing presentations, communications, and controls associated with a meeting room. Upon initial launch of the universal platform meeting management application, the method may further include invoking a first desktop application. The method may additionally include upon launch of the first desktop application, invoking a second desktop application. The method may further include executing the second desktop application independently from the universal platform meeting management application as a watchdog process. The method may further include monitoring, by the second desktop application, the universal platform meeting management application. In response to detecting an exit of the universal platform meeting management application, the method may further include re-launching the universal platform meeting management application. The method may additionally include terminating the universal platform meeting management application to allow a restart of the meeting management package.

According to further examples, the universal platform meeting management application may be executed on one or more servers. According to some examples, the method may further include defining a minimum duration period between a first launching of the universal platform meeting management application and a second launching of the universal platform meeting management application to avoid frequent launches due to a continued issue that causes the universal platform meeting management application to crash. The first launching and the second launching of the universal platform meeting management application may be successive launchings.

According to some examples, the method may further include detecting, by the second desktop application, platform availability associated with the computing device to relaunch the universal platform meeting management application. In additional examples, the method may further include displaying one or more messages in real-time on the display devices in response to detecting an exit of the universal platform meeting management application. In other examples, the method may further include prompting participants to provide user-definable input into the one or more messages, receiving the user-definable input, re-launching, by the second desktop application, the universal platform meeting management application, and terminating to allow a restart of the meeting management package.

According to additional examples, a computer-readable memory device with instructions stored thereon for providing a launch and keep-alive mechanism for a universal platform application contained within a meeting management package may be described. The instructions may include detecting a launch of a universal platform meeting management application configured to perform actions associated with managing presentations, communications, and controls associated with a meeting room. Upon initial launch of the universal platform meeting management application, the instructions may further include invoking a first desktop application. The instructions may further include managing, by the first desktop application, display devices in the meeting room based on instructions from the universal platform meeting management application. Upon launch of the first desktop application, the instructions may further include invoking a second desktop application. The instructions may further include executing the second desktop application independently from the universal platform meeting management application as a watchdog process. In other examples, the instructions may further include monitoring, by the second desktop application, the universal platform meeting management application. In response to detecting an exit of the universal platform meeting management application, the instructions may further include re-launching the universal platform meeting management application and terminating the universal platform meeting management application to allow a restart of the meeting management package.

According to some examples, the instructions may further include defining a minimum duration period between a first launching of the universal platform meeting management application and a second launching of the universal platform meeting management application to avoid frequent launches due to a continued issue that causes the universal platform meeting management application to crash. The first launching and the second launching of the of the universal platform meeting management application are successive launchings.

According to other examples, the instructions may further include detecting, by the second desktop application, platform availability associated with the computing device to relaunch the universal platform meeting management application. In other examples, the instructions may further include displaying one or more messages in real-time on the display devices in response to detecting an exit of the universal platform meeting management application, prompting participants to provide user-definable input into the one or more messages, receiving the user-definable input, re-launching by the second desktop application, the universal platform meeting management application, and terminating to allow a restart of the meeting management package.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide a launch and keep-alive mechanism for universal platform applications, the computing device comprising:
a communication interface configured to facilitate exchange of data with other computing devices;
a memory configured to store instructions associated with a meeting management application; and
a processor coupled to the communication interface and the memory, the processor configured to receive and execute a meeting management package, wherein the meeting management package includes:
a universal platform meeting management application configured to:
perform actions associated with managing presentations, communications, and controls associated with a meeting room; and
upon initial launch, invoke a first desktop application;
the first desktop application configured to:
upon launch, invoke a second desktop application; and
the second desktop application configured to execute independently from the universal platform meeting management application as a watchdog process, wherein the second desktop application is further configured to:
monitor the universal platform meeting management application;
in response to detecting an exit of the universal platform meeting management application, re-launch the universal platform meeting management application; and
terminate the universal platform meeting management application to allow a restart of the meeting management package.

2. The computing device of claim 1, wherein the first desktop application is further configured to:
manage one or more display devices in the meeting room based on instructions from the universal platform meeting management application.

3. The computing device of claim 1, wherein:
the meeting room includes sensors configured to detect activity within the meeting room, and
the sensors include one or more of: motion sensors, heat sensors, pressure sensors, and mechanical sensors.

4. The computing device of claim 3, wherein the activity within the meeting room includes one or more of: movement of participants and speech by the participants.

5. The computing device of claim 1, wherein the first desktop application is further configured to:
detect an inactivity time period associated with a select display device of the display devices; and
reactivate the select display device of the display devices in the meeting room based on instructions received from the universal platform meeting management application.

6. The computing device of claim 1, wherein the monitoring of the universal platform meeting management application includes detecting one or more of a crash of the universal platform meeting management application and a deactivation of the universal platform meeting management application.

7. The computing device of claim 1, wherein the second desktop application is configured to execute the watchdog process to:
detect faults within the monitoring of the universal platform meeting management application, and
initiate corrective actions associated with the universal platform meeting management application.

8. The computing device of claim 1, wherein the actions performed by the universal platform meeting management application include one or more of: recording the meeting, adjusting audio controls, adjusting video controls, managing online attendants, and managing presented content.

9. The computing device of claim 1, wherein the universal platform meeting management application is further configured to:
receive one or more of: content to be presented from another computing device, a communications input from the other computing device, and additional data from the other computing device.

10. The computing device of claim 1, wherein the universal platform meeting management application is further configured to:
exit due to one or more of: a software conflict, a hardware issue, and a network issue, wherein the hardware issue includes one or more of an overheating of the computing device and a lack of available memory for the computing device.

11. A method executed on a computing device to provide a launch and keep-alive mechanism for a universal platform application contained within a meeting management package, the method comprising:
detecting a launch of a universal platform meeting management application configured to perform actions associated with managing presentations, communications, and controls associated with a meeting room;
upon initial launch of the universal platform meeting management application, invoking a first desktop application;
upon launch of the first desktop application, invoking a second desktop application;
executing the second desktop application independently from the universal platform meeting management application as a watchdog process;
monitoring, by the second desktop application, the universal platform meeting management application;
in response to detecting an exit of the universal platform meeting management application, re-launching the universal platform meeting management application; and
terminating the universal platform meeting management application to allow a restart of the meeting management package.

12. The method of claim 1, wherein the universal platform meeting management application is executed on one or more servers.

13. The method of claim 11, further comprising:
waiting for a predefined minimum duration period between a first launching of the universal platform meeting management application and a second launching of the universal platform meeting management application to avoid frequent launches due to repeated crashes of the universal platform meeting management application, wherein the first launching and the second launching of the universal platform meeting management application are successive launchings.

14. The method of claim 11, further comprising:
detecting, by the second desktop application, platform availability associated with the computing device to relaunch the universal platform meeting management application.

15. The method of claim 11, further comprising:
displaying one or more messages in real-time on one or more display devices in response to detecting an exit of the universal platform meeting management application.

16. The method of claim 15, further comprising:
prompting participants to provide user-definable input into the one or more messages;
receiving the user-definable input;
re-launching, by the second desktop application, the universal platform meeting management application; and
terminating to allow a restart of the meeting management package.

17. A computer-readable memory device with instructions stored thereon for providing a launch and keep-alive mechanism for a universal platform application contained within a meeting management package, the instructions comprising:
detecting a launch of a universal platform meeting management application configured to perform actions associated with managing presentations, communications, and controls associated with a meeting room;
upon initial launch of the universal platform meeting management application, invoking a first desktop application;
upon launch of the first desktop application, invoking a second desktop application;
executing the second desktop application independently from the universal platform meeting management application as a watchdog process;
monitoring, by the second desktop application, the universal platform meeting management application;
in response to detecting an exit of the universal platform meeting management application, re-launching the universal platform meeting management application; and
terminating the universal platform meeting management application to allow a restart of the meeting management package.

18. The computer-readable memory device of claim 17, wherein the instructions further comprise:
waiting for a predefined minimum duration period between a first launching of the universal platform meeting management application and a second launching of the universal platform meeting management application to avoid frequent launches due to repeated crashes of the universal platform meeting management application, wherein the first launching and the second launching of the of the universal platform meeting management application are successive launchings.

19. The computer-readable memory device of claim 17, wherein the instructions further comprise:
detecting, by the second desktop application, platform availability associated with the computing device to relaunch the universal platform meeting management application.

20. The computer-readable memory device of claim 17, wherein the instructions further comprise:
displaying one or more messages in real-time on one or more display devices in response to detecting an exit of the universal platform meeting management application;
prompting participants to provide user-definable input into the one or more messages;
receiving the user-definable input;
re-launching by the second desktop application, the universal platform meeting management application; and
terminating to allow a restart of the meeting management package.
